(19) United States
(12) Patent Application Publication
(10) Pub. No.: US 2020/0097940 A1
(43) Pub. Date: Mar. 26, 2020

(54) PRODUCT MANAGEMENT DEVICE, CONTROL METHOD FOR PRODUCT MANAGEMENT DEVICE, AND PROGRAM

(71) Applicant: NEC CORPORATION, Tokyo (JP)

(72) Inventor: Jun UCHIMURA, Tokyo (JP)

(73) Assignee: NEC CORPORATION, Tokyo (JP)

(21) Appl. No.: 16/495,681

(22) PCT Filed: Mar. 14, 2018
(86) PCT No.: PCT/JP2018/009932

§ 371 Date: Sep. 19, 2019

(30) Foreign Application Priority Data
Mar. 22, 2017 (JP) 2017-056261

(51) Int. Cl. G06Q 20/20; G01G 19/40; G01G 19/52

(52) U.S. Cl. CPC G06Q 20/208; G01G 19/52; G01G 19/40

(57) ABSTRACT

A product management device includes: a product state detection unit including a product state detection sensor attached to a product rack and configured to detect changes in sensing states measured by the product state detection sensor; and a list output unit configured to output a list of products corresponding to the changes in the sensing states.

### TECHNICAL FIELD

The present invention relates to a product management device, a method of controlling the product management device, and a program.

### BACKGROUND ART

In recent years, the trend in unmanned systems has strengthened in response to the demand for reduction in labor costs in stores such as convenience stores and technical development therefor has been carried out. Since clerks do not perform settlement for products in such unmanned stores, various settlement methods need to be devised and thus intensive research thereon has been conducted.

For example, Patent Document 1 discloses a technology for performing settlement for product purchase on the basis of weights in a technique of product purchaser reading information such as product prices using a product reading means such as a barcode reader.

In this Patent Document 1, first, a product purchaser puts a shopping basket containing products planned to be purchased on a weight measurement means provided in a front part of a product reading means and measures the weight of the shopping basket before reading.

Next, the product purchaser takes the products out of the shopping basket and reads the products through the product reading means. Accordingly, price data and weight data of the products are acquired and a cumulative price and a cumulative weight of the purchased products are calculated.

Then, the product purchaser puts the products which have been read by the product reading means into the shopping basket on a weight measurement means provided in a rear part and measures the weight of the shopping basket after reading.

Then, the gross weight of the products identified and calculated through the product reading means is compared with the weight of the shopping basket after the products have been read, for example, and if they do not correspond to each other, all the products have not been read. It is disclosed that when they do not correspond to each other, the product purchaser is notified of this and reading of all the products is promoted.

### CITATION LIST

### Patent Literatures

[Patent Document 1]

Japanese Unexamined Patent Application, First Publication No. 2005-250931

[Patent Document 2]

Japanese Unexamined Patent Application, First Publication No. 2007-21007

### SUMMARY OF INVENTION

### Problem to be Solved by the Invention

However, when unmanned stores spread, there will be no visual checking of clerks. Accordingly, there is a problem that which product in a product display rack has been picked up by a product purchaser cannot be detected in unmanned stores.

In addition, in the technology disclosed in Patent Document 1, when all products have not been read due to an erroneous operation of the reading means and the like during settlement, the occurrence of the erroneous operation can be informed of but reference information for identifying products which have not been read is not presented. Accordingly, all products need to be read again, which is inconvenient.

Accordingly, an object of the present invention is to provide a product management device capable of ascertaining which product has been picked up by a product purchaser even in an unmanned store and presenting information which is a reference when all products have not been read due to an erroneous operation of a reading means and the like during settlement.

Patent Document 2 discloses a technique of reading radio frequency identifier (RFID) tags attached to products and a technique of detecting the weights of products on the basis of read RFID tags. However, Patent Document 2 does not disclose focusing on received signal strength indicator (RSSI) values of RFID tags, installation of sensors in product racks, and the like.

### Means for Solving the Problem

The present invention devised to solve the above-described problems employs the following configurations in order to achieve the aforementioned object.

A product management device according to an embodiment of the present invention includes a product state detection unit including a product state detection sensor attached to a product rack and configured to detect changes in sensing states measured by the product state detection sensor, and a list output unit configured to output a list of products corresponding to the changes in the sensing states.

Further, according to an embodiment of the present invention, in a method of controlling a product management device including a product state detection unit including a product state detection sensor attached to a product rack and configured to detect changes in sensing states measured by the product state detection sensor, and a list output unit configured to output a list of products, the method including controlling the list output unit to output a list of products corresponding to the changes in the sensing states.

Further, a program according to an embodiment of the present invention causes a computer of a product management device to perform process, the product management device including a product state detection unit including a product state detection sensor attached to a product rack and configured to detect changes in sensing states measured by the product state detection sensor, and a list output unit configured to output a list of products, the process including controlling the list output unit to output the list of products corresponding to the changes in the sensing states.

### Advantageous Effects of Invention

According to the present invention, it is possible to ascertain which product has been picked up by a product purchaser even in an unmanned store and to present information which is a reference when all products have not been read due to an erroneous operation of a reading means, and the like during settlement.

### BRIEF DESCRIPTION OF DRAWINGS

FIG. 1 is a diagram showing a product management device according to a first embodiment.

FIG. 2 is a diagram showing a product management device according to a second embodiment.

FIG. 3 is a first flowchart showing a method of controlling the product management device according to the second embodiment.

FIG. 4 is a second flowchart showing the method of controlling the product management device according to the second embodiment.

FIG. 5 is a third flowchart showing the method of controlling the product management device according to the second embodiment.

### DESCRIPTION OF EMBODIMENTS

### First Embodiment

### Product Management Device

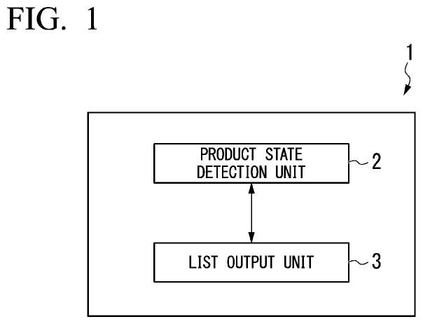

First, a product management device 1 which is a first embodiment will be described. FIG. 1 is a diagram showing the product management device 1 according to the first embodiment. The product management device 1 according to the first embodiment includes a product state detection unit 2 and a list output unit 3, as shown in FIG. 1.

The product state detection unit 2 includes product state detection sensors attached to product racks. The product state detection unit 2 is a functional unit which detects changes in sensing states measured by the product state detection sensors.

As a product state detection sensor, a gravimeter is exemplified. As a sensing state, a weight change is exemplified.

A change in a sensing state occurs when a product purchaser takes a product off a product rack by picking up the product, or the like, for example.

The list output unit 3 is a functional unit which outputs a list of products on the basis of changes in sensing states.

### Method of Controlling Product Management Device

The product management device 1 of the present embodiment controls the list output unit 3 to output a list of products on the basis of changes in sensing states.

For example, the list output unit 3 may output all products on a product rack whose weight has changed or output products corresponding to a changed weight among products on a product rack whose weight has changed. A product corresponding to a changed weight indicates a product having a weight corresponding to the changed weight, a combination of a plurality of products having a total weight corresponding to the changed weight, or a product having a weight equal to or less than the changed weight.

In the present embodiment, changes in sensing states are monitored by product state detection sensors attached to product racks and a list of products is output on the basis of changes in sensing states. Products output as a list can be regarded as products taken off a product rack due to a change in a sensing state.

Accordingly, it is possible to ascertain which product has been picked up by a product purchaser even in an unmanned store.

Therefore, it is possible to obtain marketing information about consumers' behavior which indicates not only actually purchased products but also products that are not actually purchased but are picked up and draw attention.

In addition, a list of products is also presented when RFID tags of not all products planned to be purchased have been read due to an erroneous operation of an RFID reader, and the like during settlement. Accordingly, a product purchaser can easily identify products which have not been read.

That is, since a product identified on the basis of a sensing state change is a product which has been taken off a product rack, it is product which is highly probable to be contained in a shopping basket. Accordingly, products which have already been read by the RFID reader are excluded from the list of products. Hence, it is possible to provide a list of products which are highly likely to be contained in the shopping basket and have not been read by the RFID reader.

Therefore, a product purchaser can easily identify a product which has not been read by searching the shopping basket for the product in the product list.

### Second Embodiment

### Product Management Device

Next, a product management device 11 according to a second embodiment of the present invention will be described.

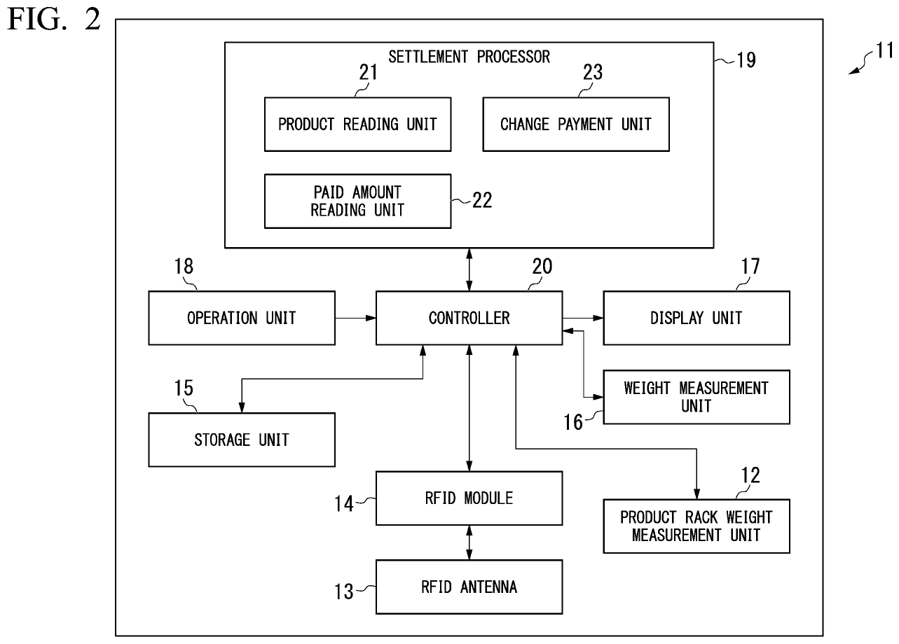

FIG. 2 is a diagram showing the product management device 11 according to the second embodiment according to the present invention. The product management device 11 of the second embodiment includes a product rack weight measurement unit 12, an RFID antenna 13, an RFID module 14, a storage unit 15, a weight measurement unit 16, a display unit 17, an operation unit 18, a settlement processor 19, and a controller 20, as shown in FIG. 2.

The product rack weight measurement unit 12 includes a weight sensor for measuring the weight of a product rack. The product rack weight measurement unit 12 outputs the weight of a product rack measured by the weight sensor to the controller 20. The weight of a product rack includes the weights of products disposed (displayed) on a product rack.

The RFID antenna 13 is an antenna which takes charge of transmitting/receiving radio waves to/from RFID tags which are tag devices attached to products and receives transmitting signals transmitted from RFID tags attached to products.

In addition, the RFID module 14 reads product identification information and RSSI values (received strengths) indicating reception states of transmitting signals from signals received by the RFID antenna and outputs these values to the controller 20.

It is desirable that a plurality of RFID antennas 13 be installed on the ceiling, product racks and the like of a store at predetermined intervals.

An RFID tag includes an IC chip having a memory in which product identification information is stored and an antenna coil.

The storage unit 15 stores various types of information about products. Specifically, the storage unit 15 stores product identification information, product names, numbers of product racks on which products are disposed, weights of products, RSSI values, RFID antenna numbers of RFID antennas that have received transmitting signals transmitted from RFID tags, and the like.

In addition, the storage unit 15 outputs such information to the controller 20 or stores such information on the basis of an instruction of the controller 20.

An RFID antenna number is a number for individually identifying an RFID antenna 13, and one number is allocated to one antenna. Likewise, a product rack number is a number for individually identifying a product rack, and one product rack number is allocated to one product rack.

The weight measurement unit 16 includes a weight sensor and the like, for example. The weight measurement unit 16 measures the weights of products that a product purchaser plans to purchase and outputs measurement results to the controller 20. As a specific measurement method, for example, a method of measuring a shopping basket containing products planned to be purchased through the weight sensor as it is may be conceived.

The display unit 17 includes, for example, a display device such as a liquid crystal panel, and displays various types of information on the basis of an output from the controller 20.

The operation unit 18 detects various operations performed by a product purchaser and outputs operation signals according to the operations to the controller 20.

The settlement processor 19 is a functional unit which includes a product reading unit 21, a paid amount reading unit 22 and a change payment unit 23 and performs a settlement process for products. The product reading unit 21 has an RFID reader for reading product identification information from an RFID tag attached to each product, and the like, for example. The product reading unit 21 outputs the read product identification information to the controller 20. Although the RFID reader can read RFID tags of all products contained in a shopping basket at one time, the RFID reader may not read RFID tags for some products depending on a positional relationship.

Further, the paid amount reading unit 22 reads an amount of money paid by a product purchaser and outputs the read amount of money to the controller 20.

In addition, the change payment unit 23 performs payment of change for the product purchaser on the basis of an instruction from the controller 20.

The controller 20 is a functional unit which receives various outputs from the product rack weight measurement unit 12, the RFID module 14, the storage unit 15, the weight measurement unit 16, the display unit 17, the operation unit 18, the product reading unit 21, the paid amount reading unit 22 and the change payment unit 23 or transmits various instructions to these components. Further, the controller 20 is a functional unit which performs various computation processes. Specific processes performed by the controller 20 will be described later.

### Method of Controlling Product Management Device

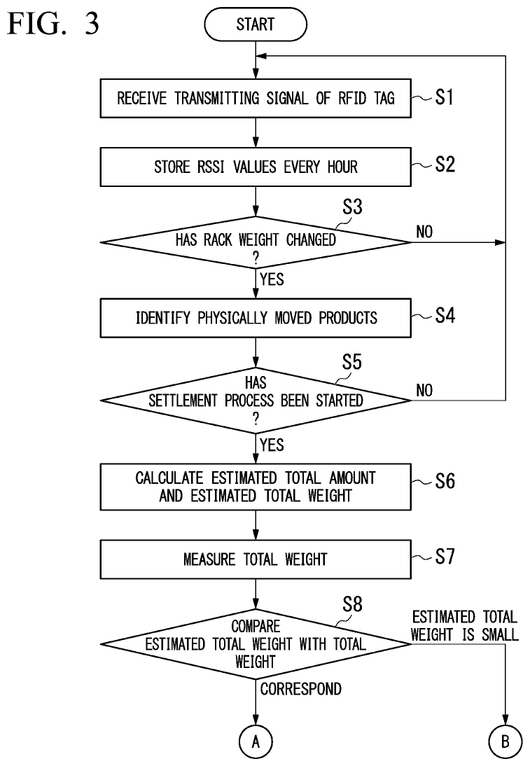

Next, a method of controlling the product management device 11 of the present embodiment will be described using FIG. 3. FIG. 3 is a first flowchart showing a method of controlling the product management device 11 according to the second embodiment.

### (Step S1)

First, transmitting signals transmitted from RFID tags are received with respect to all products in a store at a proper timing such as when a product purchaser enters the store.

Specifically, the RFID antennas 13 receive a transmitting signal transmitted from an RFID tag attached to each product. Then, the RFID module 14 reads product identification information and RSSI values from radio waves received by the RFID antennas 13 and outputs, to the controller 20, the read information and the RFID antenna number identifying the RFID antennas 13 which have received the transmitting signal.

A detection means for detecting that the product purchaser enters the store may be provided.

### (Step S2)

Next, the controller 20 outputs product identification information, RSSI values and RFID antenna numbers input in step S1 to the storage unit 15 for each specific time. The storage unit 15 stores, for each piece of product identification information, information of an RSSI value and an RFID antenna number and a time when the information is acquired.

As the specific time, an arbitrary period can be set. It is preferable to set a short period because it is desirable to continuously check RSSI values.

### (Step S3)

Next, the controller 20 checks whether the weights of product racks have changed. Specifically, the product rack weight measurement unit 12 continuously measures the weights of the product racks, and when the weight of a product rack has changed, outputs the changed weight and the number of the product rack to the controller 20. The controller 20 determines whether the weight of the product rack has changed on the basis of the output from the product rack weight measurement unit 12.

When the weight of the product rack has not changed (No in step S3), the procedure returns to step S1.

### (Step S4)

When the weight of the product rack has changed in step S3 (YES in step S3), the controller 20 identifies physically moved products.

Specifically, the controller 20 identifies products whose RSSI values have changed by a threshold value or more, whose RFID antenna numbers have changed, and which are placed on the product rack identified by the product rack number received in step S3, among products stored in the storage unit 15. Alternatively, the controller 20 may identify products which are placed on the product rack identified by the product rack number and whose RSSI values have changed by the threshold value or more, among the products stored in the storage unit 15. Alternatively, the controller 20 may identify products which are placed on the product rack identified by the product rack number and whose RFID antenna numbers have changed, among the products stored in the storage unit 15.

Products placed on the product rack whose weight changes are products which are likely to be picked up by a product purchaser.

In addition, products whose RSSI values have changed by the threshold value or more and products whose RFID antenna numbers have changed can be determined to be products that are highly likely to have been physically moved.

Accordingly, the products placed on the product rack whose weight changes and identified in step S4, and whose RSSI values have changed by the threshold value or more, or whose RFID antenna numbers have changed may be regarded as products which are highly likely to have been picked up and physically moved by the product purchaser.

### (Step S5)

Next, whether the product purchaser has started a settlement process is checked. As a checking method, for example, it is possible to check whether the product purchaser has put a shopping basket on the weight measurement unit 16. Otherwise, it is may be checked whether the product purchaser has performed an input operation for starting the settlement process using the operation unit 18.

Further, when the product purchaser does not started the settlement process (NO in step S5), the procedure returns to step S1.

### (Step S6)

When the settlement process has been started in step S5 (YES in step S5), subsequently, an estimated total amount and an estimated total weight of products planned to be purchased are calculated.

Specifically, the product reading unit 21 reads product identification information for each product by reading RFID tags attached to products contained in the shopping basket through the RFID reader. Then, the product reading unit 21 outputs the read product identification information to the controller 20.

In addition, the controller 20 identifies products stored in the storage unit 15 on the basis of the product identification information and acquires the prices and weights of the products. The controller 20 calculates an estimated total amount and an estimated total weight of all products planned to be purchased on the basis of the prices and weights of the identified products.

### (Step S7)

Next, the gross weight of the products planned to be purchased is measured.

Specifically, the weight measurement unit 16 on which the shopping basket is placed measures the total weight of the products planned to be purchased by measuring the weight of the shopping basket. In addition, the weight measurement unit 16 outputs measurement results to the controller 20.

### (Step S8)

Next, the controller 20 compares the estimated total weight calculated in step S6 with the total weight measured in step S7.

As a comparison result, the estimated total weight is quite unlikely to be greater than the total weight although it may be less than the total weight. In reading through the RFID reader, not all products may be read depending on locations of RFID tags. Further, the weight measurement unit 16 can measure the weights of all products in the shopping basket. Accordingly, the estimated total weight read by the RFID reader and calculated is always identical to or less than the weight measured by the weight measurement unit 16.

### (Step S9)

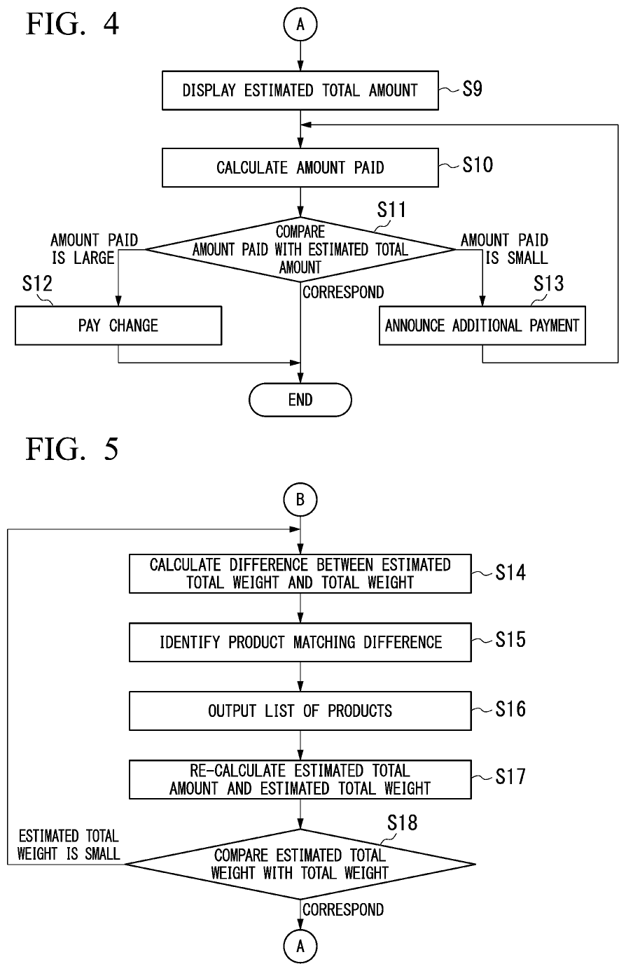

When the estimated total weight and the measured total weight are found through comparison in step S8 to correspond to each other, a price settlement procedure is performed. The price settlement procedure will be described using the flowchart of FIG. 4. FIG. 4 is a second flowchart showing the method of controlling the product management device 11 according to the second embodiment.

Specifically, the controller 20 outputs the estimated total amount calculated in step S6 to the display unit 17, as shown in FIG. 4. The display unit 17 displays the estimated total amount on the display device on the basis of an instruction of the controller 20.

### (Step S10)

Next, when the product purchaser puts money into the paid amount reading unit 22, the paid amount reading unit 22 reads the type and amount of the payment. Then, the paid amount reading unit 22 outputs information about the read amount of money to the controller 20. The controller 20 calculates the amount paid on the basis of the information about the read amount of money.

### (Step S11)

Next, the controller 20 compares the amount paid calculated in step S10 with the estimated total amount calculated in step S6.

When the amount paid calculated in step S10 and the estimated total amount calculated in step S6 correspond to each other, the present control method ends.

### (Step S12)

When the amount paid calculated in step S10 is greater than the estimated total amount as a result of comparison in step S11, the controller 20 calculates a difference between the amount paid and the estimated total amount. The controller 20 instructs the change payment unit 23 to pay the calculated difference as change. Then, the change payment unit 23 pays the change according to the instruction from the controller 20 and the present control method ends.

### (Step S13)

When the amount paid calculated in step S10 is less than the estimated total amount as a result of comparison in step S11, the controller 20 instructs the display unit 17 to announce additional payment. The display unit 17 displays an announcement of additional payment on the display device on the basis of the instruction from the controller 20. Thereafter, since the product purchaser performs additional payment, the procedure returns to step S10.

### (Step S14)

FIG. 5 is a third flowchart showing the method of controlling the product management device 11 according to the second embodiment. When the estimated total weight is found through comparison between the estimated total weight and the total weight in step S8 (FIG. 3) to be less than the total weight, an operation of outputting a list of products is started. Here, a case in which the estimated total weight is less than the total weight means that the RFID reader has not read all products in the shopping basket due to locations of RFID tags of products, and the like. In this case, products with RFID tags which have not been read are read again. The reason why the list of products is output in step S16 which will be described later is that reference information for identifying products to be read again is provided to the product purchaser.

Specifically, first, the controller 20 calculates a difference between the estimated total weight calculated in step S6 and the total weight measured in step S7, as shown in FIG. 5.

### (Step S15)

Next, the controller 20 identifies, on the basis of the difference calculated in step S14, products which are consistent with the difference among the physically moved products identified in step S4.

A product which is consistent with the difference may be a product having a weight that corresponds the difference or a plurality of products having a total weight that corresponds the difference. Further, a product which corresponds the difference may be all products having weights equal to or less than the difference.

For example, a case in which the difference is 500g may be exemplified. In this case, a product having a weight of 500g may be identified or a plurality of products having a total weight of 500g (for example, a 200g product and a 300g product) may be identified among the products identified in step S4. Otherwise, all products having weights equal to or less than 500g may be identified.

In this manner, the controller 20 identifies a product corresponding to the difference among from the products which are placed on the product rack whose weight changes, whose RSSI values have changed by the threshold value or more, or whose RFID antenna numbers have changed.

### (Step S16)

Next, the controller 20 outputs information on products obtained by excluding the products identified in step S6 from the products identified in step S15 to the display unit 17. That is, the controller 20 outputs information on products obtained by excluding products whose RFID tags have been read in the shopping basket from one or a plurality of products identified on the basis of the difference. That is, the controller 20 excludes the products whose RFID tags have been read from candidates of products whose RFID tags have not been read. Then, the display unit 17 displays the corresponding products as candidates of products whose RFID tags have not been read by the RFID reader on a liquid crystal device (display device) as a list on the basis of the output from the controller 20.

The products identified in step S6 are excluded in order to prevent the product purchaser from re-reading products whose RFID tags have already been read.

### (Step S17)

Next, an estimated total amount and an estimated total weight of the products planned to be purchased are calculated again.

Specifically, the product purchaser performs an appropriate operation such that the identified products among the products contained in the shopping basket are read by the RFID reader on the basis of the product list displayed in step S16. For example, the operation is an operation of changing the locations of the RFID tags of the products, and the like.

Then, the product reading unit 21 reads product identification information from the RFID tags of the products and outputs the read product identification information to the controller 20.

The controller 20 identifies corresponding products stored in the storage unit 15 on the basis of the product identification information and acquires the prices and weights of the products. In addition, the controller 20 re-calculates the estimated total amount and the estimated total weight of the product planned to be purchased by adding the prices and weights of the products having the newly read product identification information to the estimated total amount and the estimated total weight calculated in step S6.

### (Step S18)

Next, the estimated total weight re-calculated in step S17 is compared with the total weight measured in step S7.

When both are found through comparison to correspond to each other, the procedure proceeds to step S9 (FIG. 4). On the other hand, when the re-calculated estimated total weight is smaller than the total weight, the procedure returns to step S14. This case represents that products whose RFID tags have not been read remain. Accordingly, the processes of step S14 to step S17 are performed.

As described in step S8, there is not a case in which the re-calculated estimated total weight is greater than the total weight.

According to the above-described product management device 11 and the method of controlling the product management device 11 of the second embodiment, it is possible to ascertain which product has been picked up by a product purchaser even in an unmanned store as in the first embodiment.

In addition, when RFID tags of all products planned to be purchased have not been read due to an erroneous operation of the RFID reader, and the like during settlement, a list of products is also presented. Accordingly, the product purchaser can easily identify products whose RFID tags have not been read from a shopping basket.

Furthermore, a list of products presented in the present embodiment is a list of products which are placed on a product rack whose weight changes, whose RSSI values have changed by the threshold value or more, or whose RFID antenna numbers have changed. Accordingly, a list of products presented in the present embodiment may be regarded as a list of products which are highly likely to have been physically moved. Hence, it is possible to limit the number of products included in a list presented to a product purchaser to identify products whose RFID tags have not been read from a shopping basket more easily.

In addition, a list of products is presented to a product purchaser on the basis of a difference between a calculated estimated total weight and an actually measured total weight in the present embodiment. Accordingly, it is possible to limit the number of products included in a list presented to the product purchaser to identify products which have not been read in a shopping basket more easily.

Further, when a product purchaser enters a store, RSSI values are read. Accordingly, only products whose RSSI values have changed while the product purchaser is in the store are presented to the product purchaser as a list of products. Accordingly, it is possible to limit the number of products included in the list presented to the product purchaser to identify products which have not been read in a shopping basket more easily.

Although the present invention has been described on the basis of embodiments, the present invention is not limited to the aforementioned embodiments and can be modified in various manner without departing from the spirit or scope of the present invention.

For example, physically moved products are identified before the settlement process is started in the aforementioned second embodiment. However, physically moved products may be identified after the settlement process is started by continuously monitoring the weights of product racks and storing product rack weight data in the storage unit.

Further, in the above-described second embodiment, all products placed on a product rack whose weight changes are not regarded as identification targets and only a product corresponding to the changed weight may be regarded as an identification target when physically moved products are identified.

The product management devices 1 and 11 in the aforementioned embodiments include a computer system. In addition, a program for causing each process in the above-described product management devices to be performed is stored in a computer-readable recording medium of the product management devices, and the process is performed by reading and executing the program by a computer of a server device. Here, the computer-readable recording medium refers to a magnetic disk, a magneto-optical disc, a CD-ROM, a DVD-ROM, a semiconductor memory or the like. Further, this computer program may be delivered to a computer through a communication line and the computer which has received the delivery may execute the program.

Moreover, the aforementioned program may be a program for realizing some of functions of the above-described processing units. Further, the program may be a so-called difference file (difference program) which can realize the above-described functions according to combination with a program which has already been recorded in a computer system.

Priority is claimed on Japanese Patent Application No. 2017-056261, filed Mar. 22, 2017, the content of which is incorporated herein by reference.

### INDUSTRIAL APPLICABILITY

According to the present invention, it is possible to ascertain which product has been picked up by a product purchaser even in an unmanned store and to present information which is a reference when all products have not been read due to an erroneous operation of a reading means during settlement.

### REFERENCE SIGNS LIST

1, 11 Product management device

2 Product state detection unit

3 List output unit

12 Product rack weight measurement unit

13 RFID antenna

14 RFID module

15 Storage unit

16 Weight measurement unit

17 Display unit

18 Operation unit

19 Settlement processor

20 Controller

21 Product reading unit

22 Paid amount reading unit

23 Change payment unit

1. A product management device comprising:
a product state detection unit including a product state detection sensor attached to a product rack and configured to detect changes in sensing states measured by the product state detection sensor; and
a list output unit configured to output a list of products corresponding to the changes in the sensing states.

2. The product management device according to claim 1, wherein the product state detection sensors are gravimeters, and the changes in the sensing states are changes in weights including the weights of products placed on the product racks.

3. The product management device according to claim 1, wherein the list output unit calculates a first total weight on the basis of transmitting signals transmitted from tag devices attached to a plurality of products which are settlement targets and outputs the list of products on the basis of a difference between a second total weight obtained by measuring the plurality of products and the first total weight.

4. The product management device according to claim 1, further comprising a reception state storage unit configured to, on the basis of changes in reception states of transmitting signals transmitted from the tag devices attached to the products, store identification information of the products in which the changes have occurred,
wherein the list output unit outputs the list of products on the basis of the changes in the reception states.

5. The product management device according to claim 4, wherein the reception states are RSSI values.

6. A method of controlling a product management device including a product state detection unit including a product state detection sensor attached to a product rack and configured to detect changes in sensing states measured by the product state detection sensor, and a list output unit configured to output a list of products, the method comprising:
controlling the list output unit to output a list of products corresponding to the changes in the sensing states.

7. A non-transitory computer-readable recording medium storing a program causing a computer of a product management device to perform process, the product management device including a product state detection unit including a product state detection sensor attached to a product rack and configured to detect changes in sensing states measured by the product state detection sensor, and a list output unit configured to output a list of products, the process comprising:
controlling the list output unit to output a list of products corresponding to the changes in the sensing states.
